(19) United States
(12) Patent Application Publication
(10) Pub. No.: US 2009/0089705 A1
(43) Pub. Date: Apr. 2, 2009

(54) VIRTUAL OBJECT NAVIGATION

(75) Inventors: Ruston Panabaker, Bellevue, WA (US); Pasquale DeMaio, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/863,236

(22) Filed: Sep. 27, 2007

(51) Int. Cl. G06F 3/048

(52) U.S. Cl. 715/784

(57) ABSTRACT

A navigation manager is configured to navigate the display of an object that is larger than a computer's display based on manipulation of the display screen itself. Sensing devices associated with the display detect movement of the device and/or interaction with the display. When the movement and/or the interaction with the display is sensed, the display of the object is updated accordingly. For example, moving the display to the left may scroll the display of the object to the left, whereas pressing down on the device may zoom in on the object.

### BACKGROUND

Computers include displays that provide a limited space to show objects including documents, virtual environments and images. One way to show objects that are larger then the display of a computing device is to use scroll bars to navigate the object. For example, the scroll bars may be used to manipulate the object horizontally and vertically within the display. Manipulation of the object using the scroll bars, however, can be cumbersome and disorienting for a user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Objects that are larger than a computer's display are navigated by manipulating the display itself. Sensing devices that are associated with the display detect movement of the device and/or physical interaction with the display. When the movement and/or the physical interaction with the display is sensed, the display of the object is updated accordingly. For example, moving the display to the left may move the area of the object currently being displayed to the left, whereas pressing down on the device may cause the display to zoom the current area of the object being displayed.

### BRIEF DESCRIPTION OF THE DRAWINGS

FIG. 1 illustrates an exemplary computing device;

FIG. 2 shows a block diagram of an object navigation system;

FIG. 3 illustrates physically moving a device from one location to another location in order to navigate an object that is larger than a display screen;

FIG. 4 illustrates using cameras to navigate an object; and

FIG. 5 shows an illustrative processes for virtual object navigation.

### DETAILED DESCRIPTION

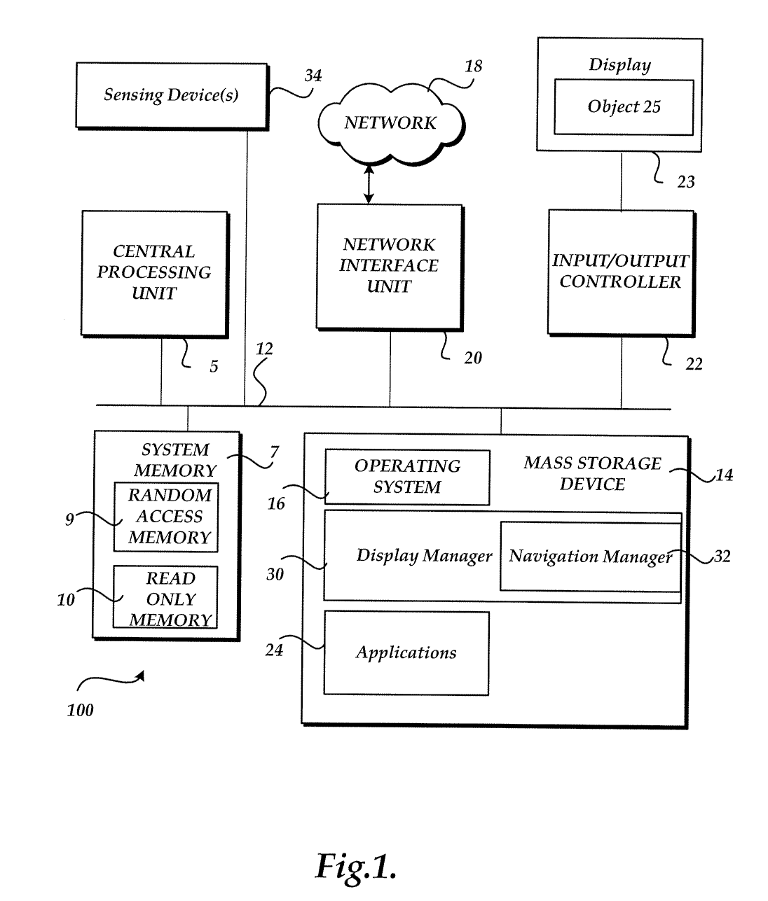

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. While the computer architecture shown in FIG. 1 is generally configured as a mobile computer, it may also be configured as a desktop. Computer 100 includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, a display manager 30, a navigation manager 32, and applications 24, which are described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 23, a printer, or other type of output device. The computer 100 also includes one or more sensing devices 34 that are designed to provide sensor information relating to movement of the device and/or physical interaction with the computing device. The sensing devices may include, but are not limited to devices such as: pressure sensors, cameras, global positioning systems, accelerometers, speedometers, cameras, and the like. Generally, any device that provides information that relates to physical interaction with the device and/or movement of the device may be utilized.

As mentioned briefly above, a number of program modules and data files may be stored in the mass storage device 14 and RAM 9 of the computer 100, including an operating system 16 suitable for controlling the operation of a networked personal computer, such as the WINDOWS® VISTA® operating system from MICROSOFT® CORPORATION of Redmond, Wash. The operating system utilizes a display manager 30 that is configured to draw to the display 23 of the computing device 100. Generally, display manager 30 draws the pixels that are associated with one or more objects to display 23. Navigation manager 32 is configured to process and evaluate information received by sensing device(s) 34 and interact with display manager 30. While navigation manager 32 is shown within display manager 30, navigation manager 32 may be separated from display manager. The mass storage device 14 and RAM 9 may also store one or more program modules. In particular, the mass storage device 14 and the RAM 9 may store one or more motion integrated application programs 24 and legacy applications 25.

Generally, navigation manager 32 is configured to receive and evaluate sensing information from sensing devices 34 and instruct display manager 30 what portion of an object (or what object to select) to render on display 23 based on the sensed information when the device is in the navigation mode. For example, when the device is in navigation mode and navigation manager 32 senses that device 100 has been physically moved, then display of the object is adjusted accordingly within display 23. Similarly, when a sensing device detects pressure on the device, a zoom factor of the object may be adjusted and then the object displayed within display 23 according to the zoom factor.

The device may enter navigation mode either manually or automatically. For example, a user may explicitly enter the navigation mode by pressing and/or holding a button or performing some other action. The device may also automatically enter the navigation mode. For example, when a device detects physical movement while an object is being displayed the navigation mode may be entered. Other ways of automatically entering the navigation mode may also be used.

The object being displayed (such as object 25) may be any type of object that is displayable. The object may be a document, an image, a virtual environment or some other display item. For example, the object could be a large map, a word processing document, a picture and the like. By using the navigation mode to display an object such as a map, a user would not have to struggle with scroll bars or get confused about where on the map the user is viewing since displaying another portion of the map may be caused by moving the device in the direction the user wants to view.

To move more efficiently while in the navigation mode a multiplier and reducer may be attached to the movement based on the sensed information. For example, to view images much larger than the space that the physical display could comfortably be moved, a multiplier may be attached to the movement such that moving the display a small distance causes a greater amount of distance to be moved in the display. Similarly, a reducer may be attached to the movement such that moving the display a large distance does not cause the object to move off of the display. Additional details regarding the display manager and motion manager will be provided below.

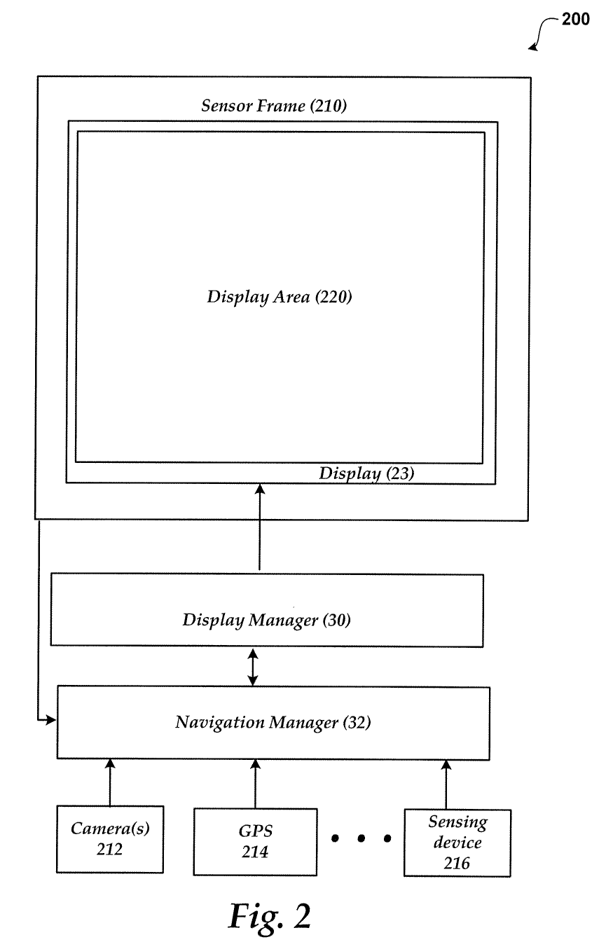

FIG. 2 shows a block diagram of an object navigation system. As illustrated, system 200 includes display 23 including display area 220, sensor frame 210, display manager 30, navigation manager 32, camera(s) 212, Global Positioning System (GPS) 214, and sensing device 216. While display manager 30 is illustrated separately from navigation manager 32, navigation manager 32 may be configured as part of display manager 30.

Display manager 30 is configured to control the drawing of the display. Display manager 30 coordinates with navigation manager 32 in order to determine what object and/or portion of an object to display within display area 220. As discusses above, navigation manager 32 is configured to receive information from sensing devices, such as one or more cameras 212, a pressure sensing device, such as from sensor frame 210, GPS device 214, or some other sensing device 216 (i.e. an accelerometer) and evaluate the sensed information to determine how to navigate an object. This sensed information (navigation event) is used in determining what portion of an object to draw to a the display area 220 of display 23. According to another embodiment, the navigation event may cause a different object to be displayed within display area 220.

According to one embodiment, a pressure sensing device, such as sensor frame 210, is used to detect pressure. When a user presses on sensor frame 210, navigation manager 32 may interpret this pressure to indicate that the display of the object is to be zoomed. Zooming of the object may also be adjusted based on the Z position of the device. For example, when the device is lifted along the Z-axis the zooming of the object may be decreased.

Alternatively, a pressure that is applied in a particular area of sensor frame 210 may be interpreted to pan/tilt the object in the direction of the pressure. According to another embodiment, the pressure may be used to advance/decrement the display within a set of images. For example, pressing on the right hand side of the sensor frame 210 on a digital camera may advance to the next stored picture, whereas pressing on the left side of sensor frame 210 may move to the previous picture. Similarly, tilting the camera to the right or left (or some other movement) may cause the image to advance to the next stored picture or move to the previous picture.

Movement of the device/display itself is also used to adjust the display of the object within display area 220. For example, when a camera 212 senses movement, or when some other sensor that is associated with the display and/or computing device detects movement (e.g. GPS 214) of the device, navigation manager 32 adjusts the display of the object in proportion to the amount of movement. For example, moving the display to the left exposes a portion of the object that is left of the display area 220.

According to one embodiment, a multiplier factor may be applied to the sensed information such that the movement of the display of the object is increased by some multiplier. For example, a 5× factor may be applied such that it takes a smaller amount of physical movement of the device to manipulate the display of the object within display area 220. This multiplier factor may be set manually and/or automatically entered. For example, a multiplier factor may be based on the size of an object. When the object is larger, then the multiplier factor is increased and when the object is smaller, then the multiplier is decreased. Similarly, the multiplier factor may be adjusted based on the density of the data within the object. When the data is dense, then the multiplier remains low, when the data is sparse then the multiplier increases. As discussed above, a reducer may also be applied.

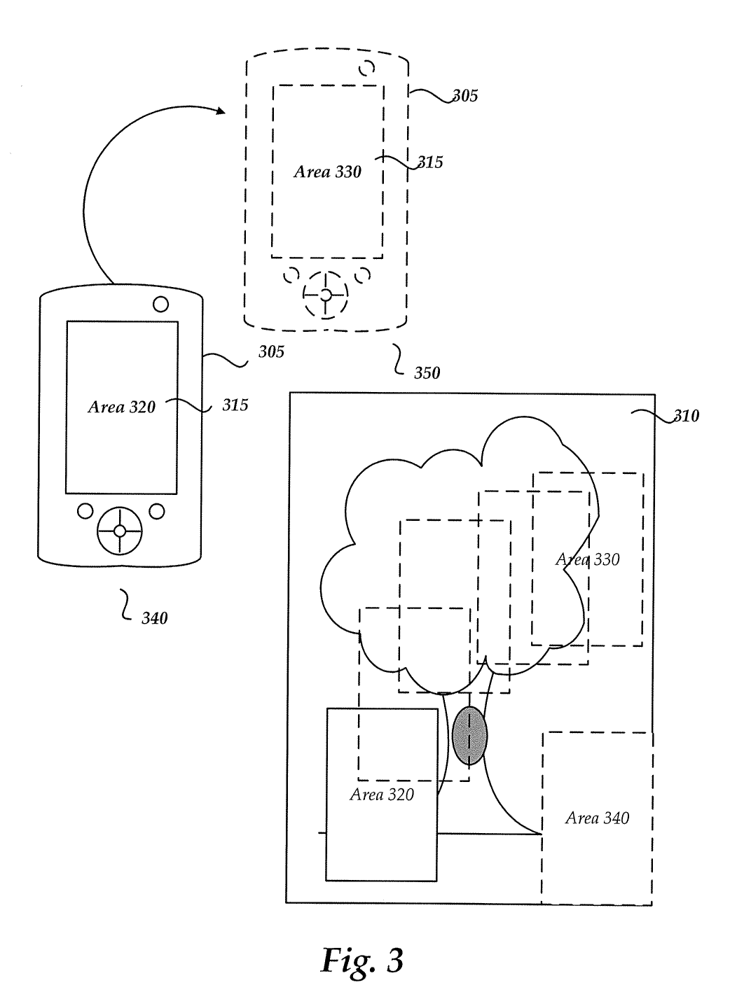

FIG. 3 illustrates physically moving a device from one location to another location in order to navigate an object that is larger than a display screen. As illustrated, device 305 has been moved up and to the right from position 340 to position 350. Object 310 shows an object that is larger then the display that is available on device 305.

Initially, when device 305 is located at position 340, display 315 shows area 320 within object 310. When device is moved from position 340 to position 350, area 330 of object 310 is displayed within display 315 of the device. The dashed boxes indicate a potential movement pattern and display while moving device 305 from position 340 to position 350. While the amount of movement of the device correlates directly to the change in the area being displayed of the object in the current example, the correlation between the movement and the display may not be directly proportional. For example, as discussed above, a smaller amount of device movement may result in a greater area being navigated within object 310 or a larger amount of device movement may result in the movement being reduced by a predetermined amount. For instance, if a user moved the device down and to the right beyond object 310, then area 340 may be displayed rather then moving beyond the end of the image.

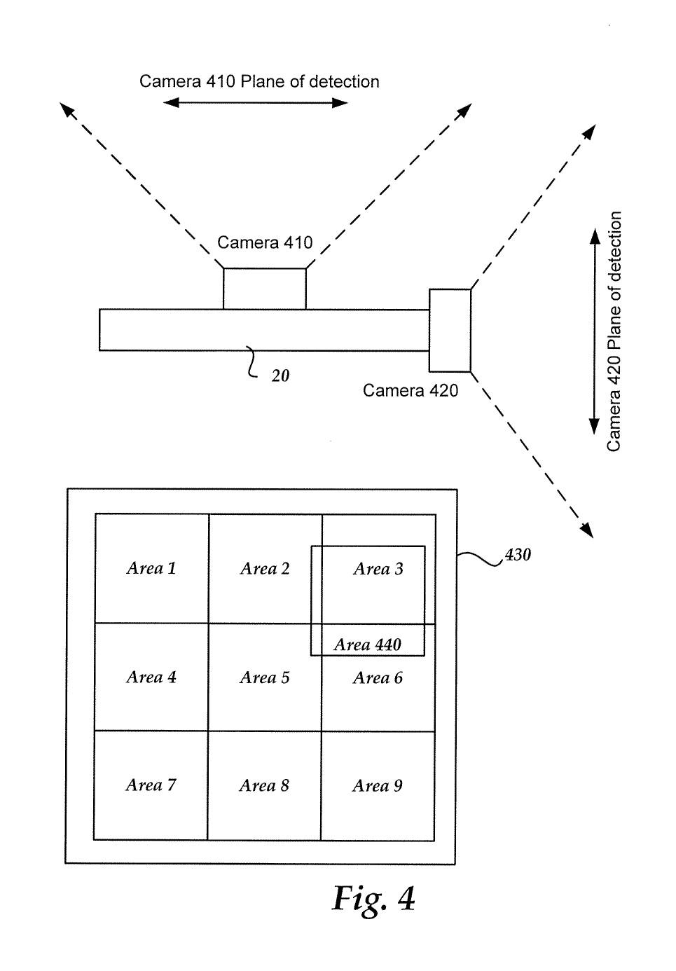

FIG. 4 illustrates using cameras to navigate an object. As illustrated, device 20 includes two cameras, camera 410 and camera 420. Two cameras orthogonally placed may be used to determine if either camera is moving in that cameras plane of detection or if the display is simply twisting on its axis. If significant movement in the same direction is detected in both cameras, then that would indicated that camera is twisting on an axis. If one camera (for example camera 410) shows movement, but the other camera (camera 4202) shows no movement or that the object is growing or shrinking then this indicates movement in the other cameras plane of detection (camera 410 plane of detection). A third camera may also be added to track all planes of movement and all three axis of rotation. According to other embodiments, more or less cameras and/or other motion sensing devices may be used to navigate an object. For instance, a laser, accelerometer or other sensing device may be used. Additionally, a camera may be mounted apart from the device such that it senses movement of the device from a fixed point. For example, one or more cameras may be mounted from a vantage point that is above the device and is capable of tracking the device when moved.

In the present example, which is for illustrative purposes only and is not intended to be limiting, when camera 410 senses movement along camera 410 plane of detection the area shown within the object moves horizontally along object 430. For example, if the current area being displayed is Area 2 and camera 410 senses movement of device 20 to the right, then Area 3 may be shown within the display. Similarly if camera 420 senses movement along camera 420 plane of detection the movement is vertical within object 430. For example, if the current area being displayed is Area 2 and the movement is vertically down then Area 5 or Area 8 may be displayed depending on the movement. While object 430 is shown in discrete areas, the area shown within the display is not so limited. For example, a movement, may show part of multiple areas (as illustrated by window 440) of object 430.

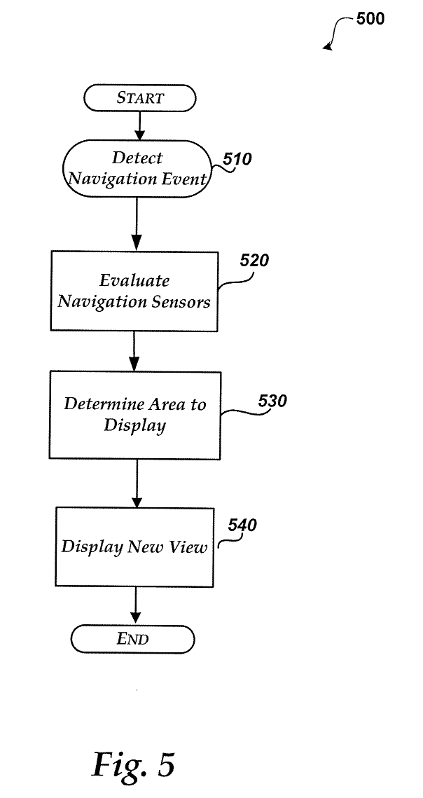

Referring now to FIG. 5, an illustrative processes for virtual object navigation will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 5, after a start operation, process 500 flows to operation 510 where a navigation event is detected. A navigation event may be configured to be any event based on motion and/or physical interaction with the device, such as motion detected in the X, Y, Z axes of the device. The physical interaction with the device may be pressure being applied to the device. The navigation event may also be based on the motion of the device stopping, an acceleration; a location change; and the like. According to one embodiment, motion and/or interaction with the device is detected using motion devices including but not limited to: pressure sensors, cameras, GPS devices; accelerometers; speedometers; and the like.

Moving to operation 520, the navigation sensors are evaluated. For example, the navigation sensor information is received and determined what type of physical interaction with the device and/or movement of the device has occurred.

Flowing to operation 530, the area to display is determined. According to one embodiment, the area to display is an area within an object that is larger then the display. According to another embodiment, the area may be another object. For example, the area may be another image (such as in the digital camera example described above).

Moving to operation 540, the new view is displayed within the display. The process the moves to an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for managing the display of an object that is larger than a display a computing device, comprising:
entering a navigation mode that uses sensed information to position the object within the display;
detecting a navigation event that is associated with the computing device;
wherein the navigation event relates to at least one of a physical movement of a display of the computing device and a change in a physical pressure that is applied to the computing device;
positioning the object within the display that is associated with the computing device based on the detected navigation event; and
displaying the positioned object within the display.

2. The method of claim 1, wherein positioning the object within the display comprises zooming in on the object when the navigation event is a downward pressure that is applied to the computing device and zooming out on the object when the navigation event senses reduced pressure.

3. The method of claim 1, wherein positioning the object within the display comprises moving the object within the display to the left when the navigation event indicates the device moves left; moving the object within the display to the right when the navigation event indicates the device moves right; moving the object within the display up when the navigation event indicates the device moves up; and moving the object within the display down when the navigation event indicates the device moves down.

4. The method of claim 1, wherein positioning the object within the display comprises rotating the object within the display when the navigation event is a rotation.

5. The method of claim 1, wherein positioning the object within the display comprises applying a predetermined multiplier to the navigation event such that the navigation of the object within the display is adjusted faster than the detected navigation event.

6. The method of claim 1, wherein entering the navigation mode comprises manually entering the navigation mode based on a user input.

7. The method of claim 1, wherein the navigation event is detected by monitoring at least a pressure sensor and a camera that is coupled to the computing device.

8. A computer-readable medium having computer-executable instructions for managing display of objects on a computing device, comprising:
detecting a navigation event that is associated with the computing device;
wherein the navigation event relates to a physical interaction with the computing device; wherein the physical interaction with the device is external from the display;
positioning an object within the display based on the detected navigation event; and
displaying the positioned object within the display.

9. The computer-readable medium of claim 8, wherein positioning the object within the display comprises determining a physical pressure that is applied to the computing device and positioning the object based on the physical pressure.

10. The computer-readable medium of claim 8, wherein positioning the object within the display comprises moving the object within the display based on a physical movement of the device.

11. The computer-readable medium of claim 8, wherein positioning the object within the display comprises determining an object to display from within a set of objects based on the navigation event.

12. The computer-readable medium of claim 8, wherein positioning the object within the display comprises applying a multiplier such that the navigation of the object within the display is adjusted faster than the detected navigation event.

13. The computer-readable medium of claim 8, wherein entering the navigation mode comprises manually entering a navigation mode based on a user input and automatically entering the navigation mode when physical interaction is detected while displaying the object.

14. A system for managing the display of an object, comprising:
a processor and a computer-readable medium;
a display;
an operating environment stored on the computer-readable medium and executing on the processor;
a sensing device that is configured to detect a navigation event that is related to a physical movement of the display; and
a navigation manager operating under the control of the operating environment; and that is operative to:
receive motion information from the sensing device;
change a position of an object within a display based on the received motion; and
display the positioned object with the display.

15. The system of claim 14, wherein the sensing device is at least two of:
a camera; a pressure sensor; a laser; an accelerometer; and a global positioning system device.

16. The system of claim 15, further comprising a frame that includes a pressure sensor that is configured to sense pressure; and wherein the navigation manager is further configured to determine when a pressure is applied and in response to the pressure change a zooming factor associated with the object.

17. The system of claim 15, wherein changing the position of the object comprises determining an amount of movement sensed and positioning the object in the display based on the amount of movement.

18. The system of claim 16, wherein changing the position of the object comprises determining an object to display from within a set of objects based on the pressure.

19. The system of claim 15, wherein changing the position of the object comprises applying a multiplier such that the position of the object within the display is adjusted faster than the sensed motion.

20. The system of claim 15, further comprising an actuator that is configured to enter a navigation mode automatically when motion is detected while displaying the object.
